(19) United States
(12) Patent Application Publication
(10) Pub. No.: US 2002/0051015 A1
(43) Pub. Date: May 2, 2002

(54) File management device and file management method

(76) Inventor: Kazuo Matoba, Akashi-Shi (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/983,677

(22) Filed: Oct. 25, 2001

(30) Foreign Application Priority Data
Oct. 30, 2000 (JP) 2000-330166

(51) Int. Cl. G06F 3/00

(52) U.S. Cl. 345/764

(57) ABSTRACT

A device and method that manage files in folders selected from among multiple folders, by newly storing in the folder, which is now an object of management by the file management program, a management file having information regarding the files residing in that folder.

### RELATED APPLICATION

This application is based on patent application No. 2000-330166 filed in Japan, the entire content of which is hereby incorporated by reference.

### BACKGROUND OF THE INVENTION

1. Field of the Invention

The present invention relates to a file management device, a file management method and a computer-readable recording medium on which a file management program is recorded, and more particularly, to a file management device and a file management method that manage files that are stored in a storage device that can store multiple files in each folder, as well as to a computer-readable recording medium on which is recorded a file management program that manages files that are stored in a storage device that can store multiple files in each folder.

2. Description of the Related Art

A document management system that manages multiple files in a comprehensive manner is known in the conventional art. According to this conventional document management system, a management file that holds such information as the file name, the folder in which the file is stored, the file size, the revision date and keywords regarding each file is created such that multiple files can be managed in a comprehensive manner. Therefore, if one views the management file, one can immediately see management information such as the folder under which the subject file is stored, the file size and the revision date thereof. In addition, because the management file is stored in one place, information regarding any file can be registered, changed or deleted, or a keyword search can be performed, simply by accessing the management file.

However, using the conventional document management system, when a folder or file is moved or a copy thereof is made using a software program other than the document management system, the information stored in the management file no longer matches the actual situation. For example, where a file (a) in a folder A is moved to a folder B using a software program other than the document management system, the file (a) no longer exists in the folder A. However, when this situation is present, the management file of the document management system still stores information indicating that the file (a) exists in the folder A, which is different from the actual situation.

Furthermore, a problem occurs when the document management system is applied in a personal computer to which an external storage device such as a removable hard disk is connected. Where a file stored in the external storage device is an object of management by the document management system, if the external storage device is removed from the personal computer, the document management system cannot detect the removal of the external storage device, so that the information in the management file no longer matches the actual situation.

### SUMMARY OF THE INVENTION

An object of the present invention is to resolve the problems identified above.

Another object of the present invention is to provide a file management device and method that can easily manage multiple files.

Yet another object of the present invention is to provide a file management device and method that can correctly manage folders and files even when such an operation as moving a file is performed using another software program.

These and other objects are attained by a file management method that manages files in folders, and the method includes a step of obtaining file information regarding files in a folder and a step of creating in the folder a management information file that contains information that associates the obtained file information and each file.

These and other objects are also attained by a file management method that manages some folders selected from among multiple folders and files in the selected folders, and the method includes a step of accepting a selection of folders that are to be managed and a step of creating in each of the selected folders, a file that indicates that the each of the selected folders is an object of management.

These and other objects are also attained by a file management device includes a memory that has at least one folder which is available to store a plurality of data files, a file information obtaining unit that obtains file information for each of the plurality of data files included in a folder, a management information file creating unit that creates a management information file in which the obtained file information is stored while being associated with the data file, and a processing unit that stores the created management information file in the folder.

The invention itself, together with further objects and attendant advantages, will best be understood by reference to the following detailed description taken in conjunction with the accompanying drawings.

### BRIEF DESCRIPTION OF THE DRAWINGS

FIG. 1 is a block diagram showing the basic construction of the file management device;

FIG. 2 is a drawing showing the file construction in the file management device;

FIG. 3 is a flow chart showing the file management routine;

FIG. 4 is a flow chart showing the startup routine of the file management program;

FIG. 5 is a flow chart showing the additional information editing routine;

FIG. 6 is a drawing showing one example of the management information file format;

FIG. 7 is a drawing showing the file construction in the file management device (the second embodiment);

FIG. 8 is a drawing showing an example of the management information file format (the second embodiment);

FIG. 9 is a flow chart showing the folder link routine;

FIG. 10 is a drawing showing one example of the function selection screen; and

FIG. 11 is a flow chart showing the folder link cancellation routine.

In the following description, like parts are designated by like reference numbers throughout the several drawings.

### DESCRIPTION OF THE PREFERRED EMBODIMENTS

Embodiments of the present invention are described below with reference to the drawings. In the drawings, the same numbers are used for identical or equivalent members, and the descriptions thereof will not be repeated.

[First Embodiment]

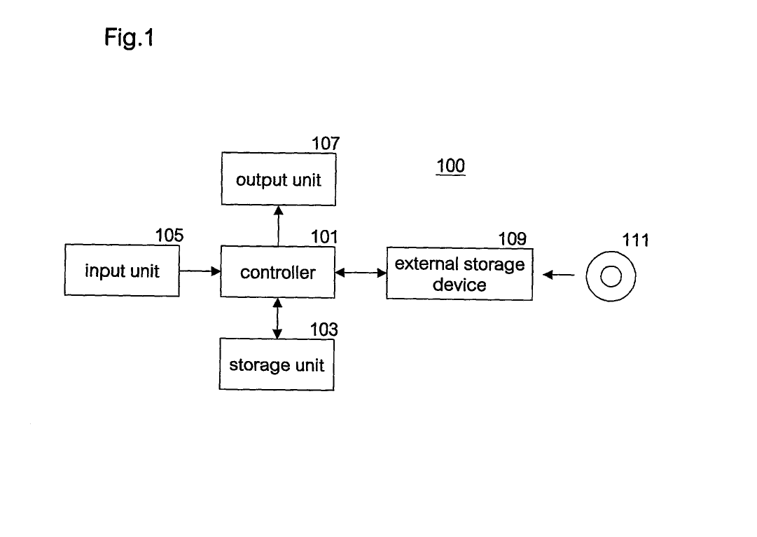

FIG. 1 is a block diagram showing the basic construction of the file management device pertaining to a first embodiment of the present invention. The file management device 100 can comprise a personal computer or the like, and includes a controller 101 to control the entire file management device, an input unit 105 by which to input data, a storage unit 103 in which to store data, an output unit 107 to which to output data and an external storage device 109 in which to store the programs, etc. that are executed by the controller 101.

The controller 101 has a central processing unit (CPU), a read-only memory (ROM) in which programs executed by this CPU are stored, and a random access memory (RAM) in which are stored variables, etc. that are needed when the CPU executes such programs.

The input unit 105 comprises a keyboard and a mouse, and letters, numbers and prescribed instruction commands can be input using the input unit.

The storage unit 103 stores such data as document and/or image information. Such data can be, for example, a data file created using a word processing application program, a data file created using a spreadsheet application program, a data file to store images read using a digital camera, an image scanner or the like, or a data file created using various other application programs.

The storage unit 103 also has multiple folders, and can store the data files in different folders. For example, data files created using a word processing program can be stored in a folder A, while data files created using a spreadsheet program can be stored in a folder B. Furthermore, different folders can be created for different subjects, or a different folder can be created for a prescribed period of time based on the time at which the data file is created. These folders are created using a public domain application program.

The output unit 107 is a display, and displays data files in the form of thumbnail images in accordance with instructions from the controller 101. Consequently, multiple data files can be displayed at the same time. The output unit 107 can be a printer instead.

The external storage device 109 reads programs and/or data recorded on the computer-readable recording medium 111, and transmits them to the controller 101. It also writes needed data in the computer-readable recording medium 111 in accordance with instructions from the controller 101.

For the computer-readable recording medium 111, a medium that carries programs in a stationary fashion can be used, including a tape such as a magnetic tape or a cassette tape, a magnetic disk (flexible disk, hard disk device or the like), a disk such as an optical disk (CD-ROM, MO, MD, DVD or the like), a card such as an IC card (including a memory card) or an optical card, a mask ROM, an EPROM, or a semiconductor memory such as a flash memory. Alternatively, the recording medium 111 can comprise a medium that stores programs in a flexible manner such that a program can be downloaded from a network.

When the external storage device 109 reads the file management program recorded on the recording medium 111, the controller 101 can execute the read program.

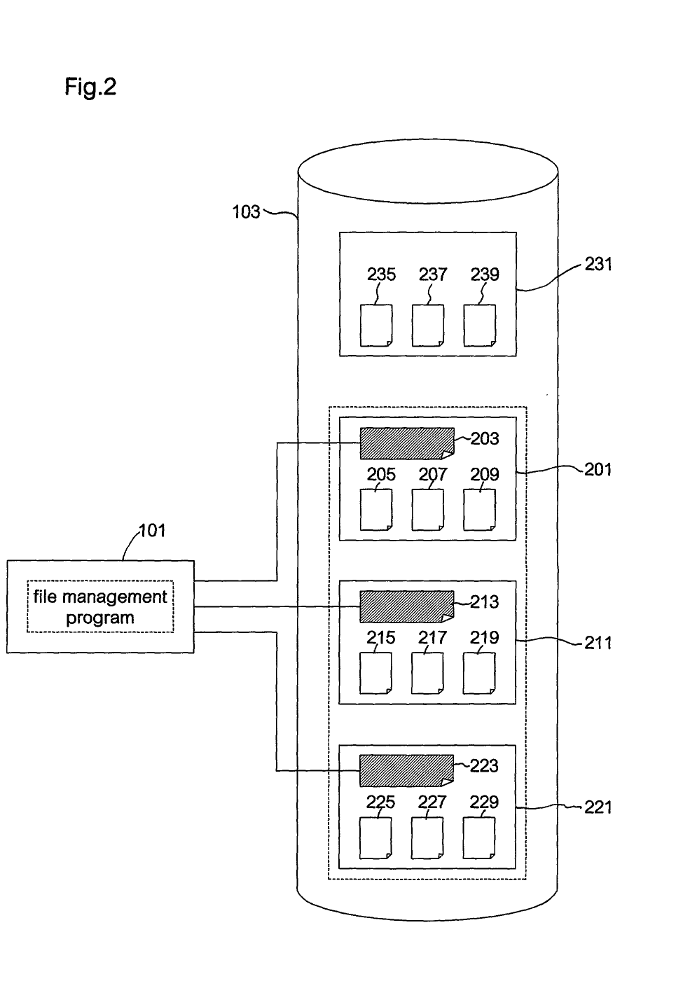

FIG. 2 is a drawing showing the file construction in the file management device 100 of the first embodiment. The controller 101 executes the file management program. The storage unit 103 includes four folders 201, 211, 221 and 231. Each of these folders 201, 211, 221 and 231 holds multiple data files. In this example, a situation will be described in which the folder 231 is a folder that is not managed by the file management program, and the folders 201, 211 and 221 are folders that are managed by the file management program.

In FIG. 2, three data files 205, 207 and 209 are stored in the folder 201, three data files 215, 217 and 219 are stored in the folder 211, three data files 225, 227 and 229 are stored in the folder 221, and three data files 235, 237 and 239 are stored in the folder 231.

The folders 201, 211 and 221, which are managed by the file management program, also store management information files 203, 213 and 223, respectively, in addition to the data files. On the other hand, the folder 231, which is not managed by the file management program, stores only the three data files 235, 237 and 239, and does not have a management information file.

The management information files 203, 213 and 223 are created by the file management program executed by the controller 101. A management information file includes the file information regarding the data files stored in the folder that stores the management information file. For example, the management information file 203 in the folder 201 includes file information regarding the three data files 205, 207 and 209. The management information file 213 in the folder 211 includes file information regarding the three data files 215, 217 and 219, and the management information file 223 in the folder 221 includes file information regarding the three data files 225, 227 and 229. File information includes data file attribute information and additional information.

As described above, a folder that is managed by the file management program has one management information file, and the management information file includes file information only regarding the data files stored in the same folder.

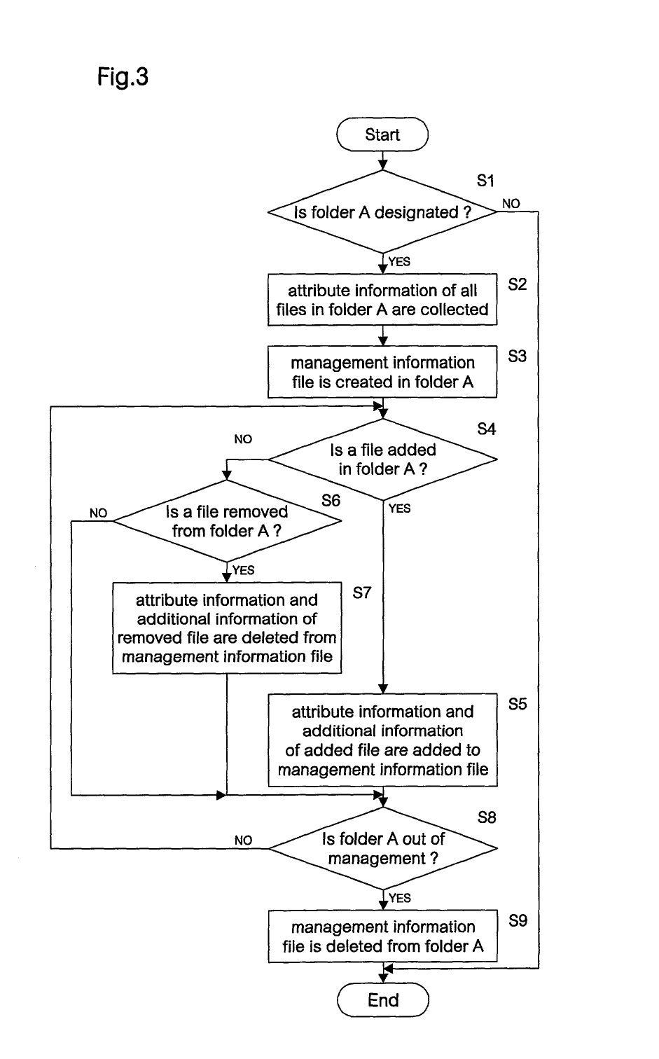

FIG. 3 is a flow chart showing the sequence of the file management process performed by the file management device of the first embodiment. The file management device 100 determines whether or not a particular folder A has been designated from among the folders stored in the storage unit 103 as an object of management by the file management program (step S1). Designation of a folder is carried out by the operator of the file management device 100 using the input unit 105. In order to simplify the description, it is assumed here that the designated folder is the folder A.

Where the folder A is designated, the file management device 100 advances to step S2, and otherwise the process comes to an end. In step S2, the attribute information regarding all data files in the folder A is collected. Attribute information here comprises the file name, the file size and the revision date regarding each data file, for example. Attribute information can be obtained in the same manner in which it is obtained by the operating system. Information that is contained in each data file itself can be obtained from each data file. Information contained in each data file itself can also be obtained each time such information is needed.

In the next step S3, the attribute information and additional information regarding each data file are associated with each other and a management information file is created. At this point, only subject items are created for the additional information, and no contents are included as data. The created management information file is then stored in the folder A designated in step S1.

In the next step 4, it is detected whether or not a new data file has been added to the folder A. If a data file has been added, the file management device 100 advances to step S5, and if not, it advances to step S6. In step S5, the attribute information and additional information regarding the added data file are associated with each other and are added to the management information file.

In step S6, it is determined whether or not a file has been removed from the folder A. If a file has been removed, the file management device 100 advances to step S7, and if not, it skips step S7 and advances to step S8. In step S7, the attribute information and additional information regarding the removed data file are deleted from the management information file.

In step S8, it is determined whether or not the folder A is no longer an object of management by the file management program. Where it is no longer an object of management, the file management device 100 advances to step S9, and if not, it returns to step S4, in which the above steps are repeated. In step S9, the management information file is deleted from the folder A.

Simply by deleting the management information file from the folder A, the data files stored in that folder can be excluded from management by the file management program.

Addition or removal of a data file to or from a folder, and deletion of a folder, are carried out under the control of the file management program executed by the controller 101. Instructions for these operations are issued by the operator of the file management device 100 using the input unit 105.

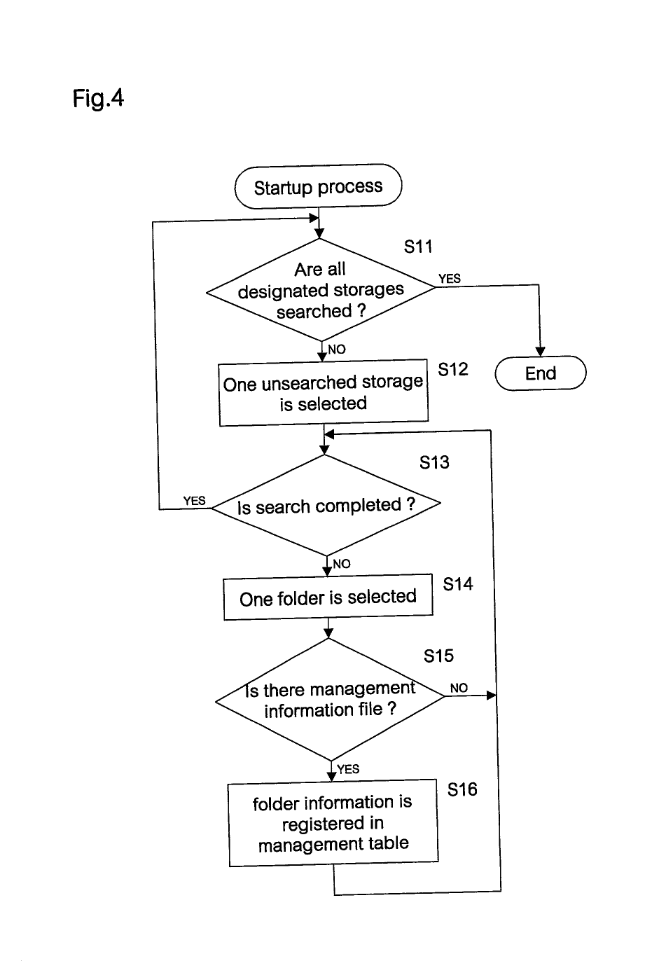

FIG. 4 is a flow chart showing the sequence of the startup process of the file management program executed in the file management device pertaining to the first embodiment. When the file management program is booted, it is determined whether or not all of the designated storage devices have been searched (step S11).

It is assumed in this example that the storage unit 103 has multiple storage devices. The phrase 'all of the designated storage devices' means the storage devices that are designated from among the multiple storage devices by the operator of the file management device 100 using the input unit 105. It is acceptable if all or only some of the storage devices incorporated by the storage unit 103 are designated. Furthermore, it is also acceptable if the external storage device 109 is also included in addition to the storage unit 103. The term ‘search’ means the operation to retrieve, from among the folders stored in the storage unit 103 or the external storage device 109, folders that contain a management information file.

One storage device is selected from among the designated storage devices that have not yet been searched (step S12), and it is determined whether or not the search for folders that contain a management information file has been completed with regard to the selected storage device (step S13). Where the search has been completed, the file management device 100 advances to step S11, and where the search has not been completed, the file management device 100 advances to step S14.

In step S14, one folder to be stored in the designated storage device is selected, and it is determined whether or not a management information file is stored in that folder (step S15). Where there is a management information file, the file management device 100 advances to step S16, and if not, the file management device 100 returns to step S13.

In step S16, the information regarding the folder in which a management information file is stored is registered in the management table. This ‘folder information’ includes the access route and the management information file name for that folder. A direct path or relative path can be used for the access route. The management table includes information associating the access route and the management information file name for the folder that contains the management information file.

When the startup process is completed, the folders that contain a management information file can be immediately determined by referring to the management table. It is also acceptable if the contents of the management information file are included in the management table.

In this embodiment, the startup routine of the file management program is carried out when the file management program is booted, but the search for and registration of folders, which are managed by the file management program, can be executed at times other than startup.

As described above, in the file management device pertaining to the embodiment, a management information file is contained in each folder, and the folders that have a management information file are sought when the file management program is booted. As a result, files that are stored in the external storage device 109, which can be temporarily connected to or removed from the file management device 100, can be included as objects of management by the file management program when the external storage device 109 is connected. That is, the files stored in the external storage device 109 can be deemed to be managed by the file management program when the external storage device 109 is connected to the file management device 100 while they are not so deemed when the external storage device 109 is not connected.

In addition, where a folder containing files managed by a different file management device has been stored in the storage unit 103 via a recording medium such as a floppy disk or via a network or a removable drive, the data files stored in that folder can immediately be included by the file management program as objects of management.

Furthermore, if a storage device-equipped portable terminal, scanner, combination device comprising a scanner and a printer, or copying machine that can receive data from a personal computer for printing can be connected to the file management device 100, the data files in these storage devices can be made the objects of management by the file management program as well.

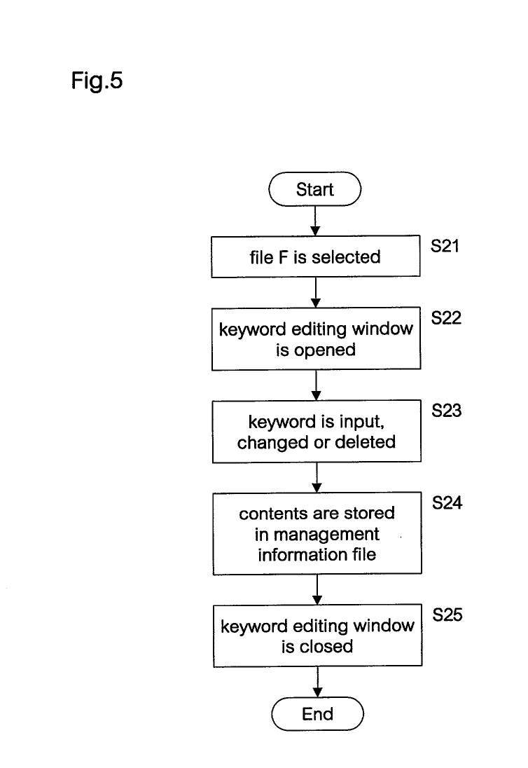

FIG. 5 is a flow chart showing the sequence of the additional information editing process performed by the file management device pertaining to the first embodiment. In the additional information editing process, a file that resides in a folder that is the object of management is first selected (step S21). Selection of a file is carried out by the operator of the file management device 100 using the input unit 105. In this example, descriptions will be provided assuming the selected file to be a file F.

A keyword editing window is read from the storage unit 103 (step S22) and is displayed in the output unit 107. A keyword is then input, changed or deleted by the operator using the input unit 105 (step S23). When the operator instructs execution of the process, the contents of the edited keyword are stored in the management information file stored in the folder, which is managed by the file management program (step S24). The keyword editing window output in the output unit 107 is then closed (step S25).

A window in which a comment can be input can be included in the keyword editing window. It is also acceptable if a window in which a comment can be input is displayed in the output unit 107 separately from the keyword editing window, and a comment can be input using the input unit 105. In addition to a keyword and a comment, a marker expressed using an image can be associated with the selected file. A marker comprises an image, and consists of a line, a letter, a figure, a symbol or a combination thereof, for example.

The location of the marker in the data file and the shape of the marker, which comprise additional information, are stored in the management information file. For example, where a thin red line is to be added under the first line of the first page of the data file, ‘thin red line’ information is stored as the marker shape, and the coordinates of the point at which the line begins and the coordinates of the point at which it ends, in a coordinate system in which the left upper corner of the document is deemed the origin, are stored as location information.

The shape and location of a marker are designated by the operator using the input unit 105. The file F is output to the window in the output unit 107. The operator can check the contents of the file F via the output unit 107. The operator selects a marker shape when this state is present, and inputs the marker via an operation as if to draw the marker on the output unit 107 on which the contents of the file F are displayed. Through this operation, the marker location and size are input. It is convenient if the marker can be moved and changed in shape using the same method. The window in which a marker is input can be simultaneously or separately displayed with the window in which a keyword or a comment is input.

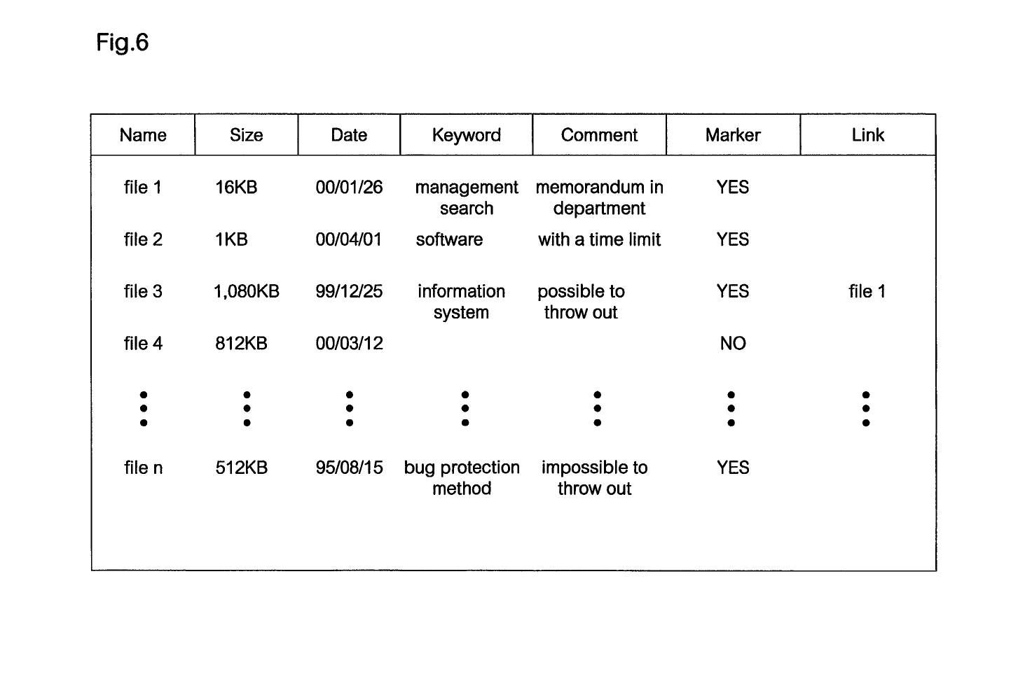

FIG. 6 is a drawing showing one example of the format for the management information file created by the file management device 100 pertaining to the first embodiment. A management information file includes ‘Name’, which indicates the name of the data file, ‘Size’, which indicates the size of the data file, ‘Date’, which indicates the date on which the data file was last revised, ‘Keyword’, which indicates the keywords associated with the data file, ‘Comment’, which indicates the comments regarding the data file, ‘Marker’, which indicates whether or not there is a marker associated with the data file, and ‘Link’, which indicates links among data files.

For example, it can be seen that the data file having the file name ‘File 1’ has a file size of 16KB, was last revised on Jan. 26, 2000, and has ‘management’ and ‘search’ as keywords, ‘circulate in department’ as a comment, and a marker. As for the file named ‘File 3’, because ‘File 1’ is registered under ‘Link’, File 1 and File 3 are linked and are treated by the file management device 100 as a single file.

More specifically, all of the multiple data files linked under ‘Link’ are read out together. When this occurs, even if the multiple data files were created using different application programs, the application programs used for each of the multiple data files are booted such that all of the multiple data files are read out and output images are created, which are then displayed as one set of thumbnail images, which overlap each other, in the output unit 107. When the thumbnail images are page forwarded, the uppermost thumbnail that is displayed changes, and as a result, the contents of multiple data files are sequentially displayed.

In this embodiment, ‘YES’ or ‘NO’ is used to indicate whether a marker is added. In the case of ‘YES’, a marker image file is associated with the data file. Marker image data can be included in this item of the management information file. It is also preferred that the management information file have a name that is related to the name of the folder that is the object of management by the file management program. Furthermore, it is preferred that the management information file have a special file format such that the contents of the management information file cannot be altered by other software programs.

Because the file management device of the first embodiment creates a management information file including the data file additional information for each folder as described above, it is not necessary to consider the folder in which the data file is stored. Therefore, multiple files can be easily managed without paying attention to the folders. In addition because a folder can be made an object of management by the file management program simply by virtue of the fact that a management information file exists in that folder, management of data files can be made easy.

Furthermore, because the management information file includes the file size, date of revision and keywords for each data file name, data file selection, searches and the like can be performed using these items. Furthermore, because the management information file includes the item ‘Link’, which links one data file to other data files, multiple data files can be easily linked.

Moreover, because linked data files are displayed as one set of overlapping thumbnail images, the operator can handle the linked data files as a single file. Furthermore, a data file can be eliminated as an object of management by the file management program by deleting the pertinent management information file from the folder, which enables easy operation.

[Second Embodiment]

The file management device pertaining to a second embodiment will now be described. The file management device pertaining to the second embodiment has the same features as the file management device of the first embodiment, and using this file management device, folders can be linked. The file management device pertaining to the second embodiment has the same basic construction as the file management device pertaining to the first embodiment, and only the differences are described below.

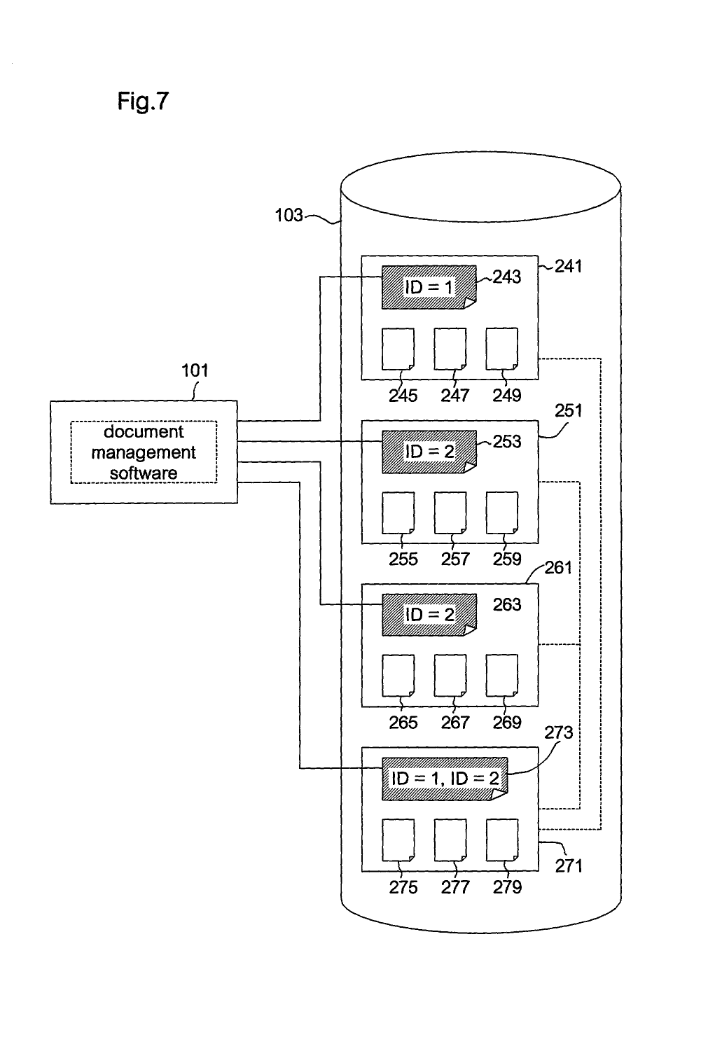

FIG. 7 is a drawing showing the file construction for the file management device pertaining to the second embodiment. The storage unit 103 includes four folders 241, 251, 261 and 271. Each folder is an object of management by the file management program, and they respectively include management information files 243, 253, 263 and 273. Each management information file has an ID number. In this example, the management information file 243 has an ID number ‘1’, the management information file 253 in the folder 251 has an ID number ‘2’, the management information file 263 in the folder 261 has an ID number ‘2’, and the management information file 273 in the folder 271 has ID numbers ‘1’ and ‘2’.

The ID number is added by the file management program executed by the controller 101. By including an ID number in the management information file in this way, multiple folders having the same ID number can be linked to each other. For example, the data files included in the multiple folders having the ID number ‘1’ can be handed as data files in a single folder. More specifically, management information files having an ID number ‘1’ are the management information file 243 and the management information file 273. Therefore, the data files 245, 247, 249 included in the folder 241 and the data files 275, 277 and 279 included in the folder 271 can be handled as if they resided in a single folder.

In addition, the number of ID numbers included in one folder is not limited to one, but instead, a folder can have multiple ID numbers. By doing so, one folder can be linked to different folders. For example, the management information file 273 in the folder 271 has ID numbers ‘1’ and ‘2’, such that it is linked to other folders having an ID number ‘1’ as well as to other folders having an ID number ‘2’. In this example, the folder 241 and the folder 271 are linked to each other via the ID number ‘1’, and the folder 251, the folder 261 and the folder 271 are linked to each other via the ID number ‘2’.

Linking and cancellation of links are executed via a prescribed operation regarding folders. This will be described in detail below. Where a linked folder, which is an object of management by the file management program, is lost from the storage unit 103 for some reason, the file management program automatically cancels the link to that folder because the management information file for that folder no longer exists. Conversely, where a linked file, which is an object of management by the file management program, is recovered in the storage device and the file management program recognizes the management information file for that folder when booted, the link to that folder is restored.

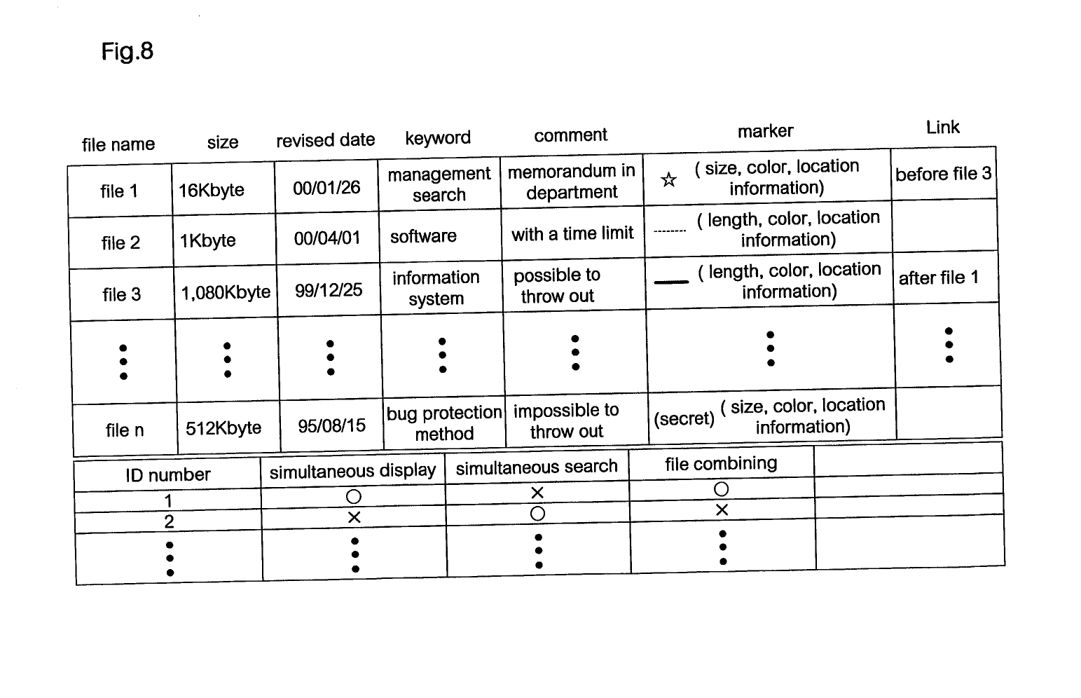

FIG. 8 is a drawing showing one example of the format for the management information file created by the file management device pertaining to the second embodiment. In addition to the file format in the first embodiment in which links are shown, the management information file has ‘ID number’, which indicates links among folders, as well as three additional items that indicates the nature of the link, i.e., ‘Simultaneous display’, ‘Simultaneous search’, and ‘File combination’. Under ‘ID number’ is stored the ID number for linking purposes. This example shows a situation in which two ID numbers ‘1’ and ‘2’ are used. Where the ID number is ‘1’, files in the linked folders are simultaneously displayed, but simultaneous searching is not performed, and these files are combined.

Where the ID number is ‘2’, data files in the folders having the ID number ‘2’ are not simultaneously displayed or combined, and only simultaneous searching is carried out.

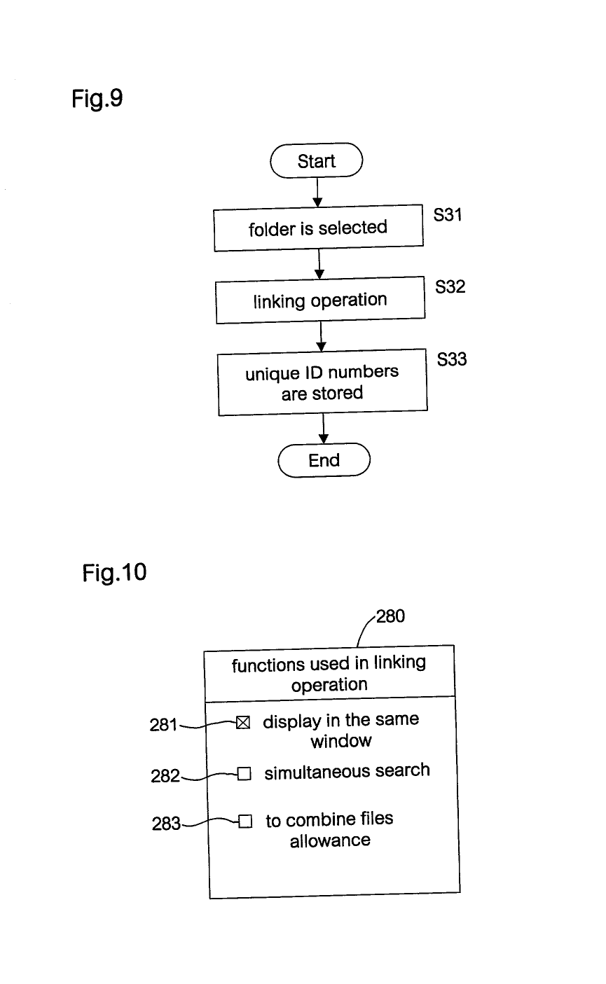

FIG. 9 is a flow chart showing the sequence of the folder linking process carried out by the file management device pertaining to the second embodiment. In the folder linking process, folders to be linked together are first selected from among the folders that are the objects of management by the file management program (step S31). This selection is performed by the operator of the file management device 100 using the input unit 105. Any number of folders can be selected in this step, but must comprise a minimum of two.

A linking operation is then executed with regard to the multiple folders thus selected (step S32). A linking operation is a process in which linking with respect to the three items of ‘simultaneous display’, ‘simultaneous search’ and ‘file combination’ should be made.

When the linking operation is completed, the unique ID numbers are stored in the management information files of the selected multiple folders (step S33). For the folders linked in this way, files are displayed in a window and/or combined as if they were stored in a single folder. In addition, multiple linked folders can be automatically included as search objects simply by designating one ID number. However, it is possible not to handle linked folders as a single folder at all times, and to enable or disable the linking based on the wishes of the user of the file management device 100. This can be done by making selectable the function enabling the linking of folders, which are objects of management by the file management program and have ID numbers.

FIG. 10 is a drawing showing one example of the function selection screen displayed in the file management process in the second embodiment. The function selection screen 270 displays the three functions ‘Display in same window’, ‘Simultaneous search’ and ‘File combination permitted’, which comprise different link functions. Checking the check boxes 271, 272 and 273 that correspond to each function enables each checked function. For example, if the ‘Display in same window’ function is enabled, when the data files stored in the link folders are displayed, all of the data files are displayed in the same window as if they resided in the same folder. Where the ‘Simultaneous search’ function is enabled, all of the data files included in the linked multiple folders are deemed the objects of search. In this case, if some of the linked folders are selected for the search, the data files of all of the linked folders are deemed objects to be sought.

Where the ‘File combination permitted’ function is enabled, data files can be combined between different folders. For example, a data file (a) stored in the folder A can be combined with a data file (b) stored in the folder B. Where this function to combine files is not enabled, data files can not be combined between different folders. In the file management device, if file combination is designated, two or more files are handled as a single file, enabling display via thumbnail images, editing by an application program, one-time file deletion and the like.

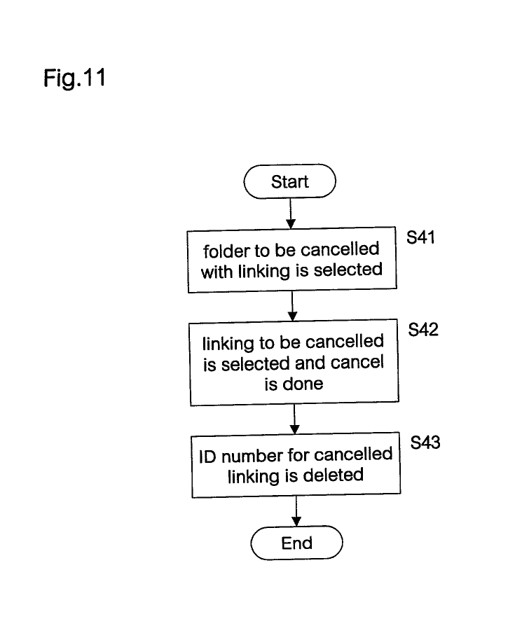

FIG. 11 is a flow chart showing the sequence of the folder link cancellation process that is carried out by the file management device of the second embodiment. In the folder link cancellation process, a folder, the link to which is to be cancelled, is first selected from among the linked folders that are managed by the file management program (step S41). Selection of a folder is performed by the operator who operates the file management device 100 using the input unit 105. The type of link to be cancelled regarding the selected folder is then selected, and the cancellation is executed (step S42).

During this operation, the function selection screen shown in FIG. 10 is displayed in the output unit 107, and the operator instructs cancellation of link using the input unit 105. In order to instruct cancellation of a link, the operator double-clicks on the check box 271, 272 or 273 using a mouse or other input device, whereupon the check mark is removed. The ID number associated with the cancelled link is then removed from the management information file for the selected folder (step S43).

As described above, in the file management device pertaining to the second embodiment, each folder has a management information file, and ID numbers are stored in the management information file as well. Consequently, in addition to the effects of the file management device of the first embodiment, folders can be linked such that multiple data files can be managed without paying attention to the fact that they are stored in different folders.

The embodiments disclosed above are only examples in all aspects and should in no way be construed as limiting the scope of the present invention. It is intended that the scope of the present invention be indicated not by the descriptions above but by the claims, and that it includes all changes within the meaning and scope equivalent to the claims.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A file management method that manages files in folders, the method comprising the steps of:
obtaining file information regarding files in a folder; and
creating in the folder a management information file that contains information that associates the obtained file information and each file.

2. A file management method that manages some folders selected from among multiple folders and files in the selected folders, the method comprising the steps of:
accepting a selection of folders that are to be managed; and
creating in each of the selected folders, a file that indicates that the each of the selected folders is an object of management.

3. A file management device comprising:
a memory that has at least one folder which is available to store a plurality of data files;
a file information obtaining unit that obtains file information for each of the plurality of data files included in a folder;
a management information file creating unit that creates a management information file in which the obtained file information is stored while being associated with the data file; and
a processing unit that stores the created management information file in the folder.

4. A file management device as claimed in claim 3, wherein the obtained file information includes a keyword.

5. A file management device as claimed in claim 3, wherein the obtained file information includes link information making an association with another data file.

6. A file management device as claimed in claim 5, further comprising:
reading means which reads out the management information file; and
display which display data files that are associated by the link information when the link information is in the management information file.

7. A file management device as claimed in claim 3, further comprising deleting means which deletes the management information file from the folder.

8. A file management device as claimed in claim 3, further comprising associating means which provides each management information file stored in a plurality of folders with a common identify number.

9. A file management program that manages some folders selected from among multiple folders and files in the selected folders, the program comprising the steps of:
accepting a selection of folders that are to be managed;
obtaining file information for each of a plurality of data files included in the selected folder;
creating a management information file making an association between the obtained file information and the data file; and
storing the created management information file in the selected folder.
